(19) United States
(12) Patent Application Publication
(10) Pub. No.: US 2007/0127555 A1
(43) Pub. Date: Jun. 7, 2007

(54) Methods of geographically storing and publishing electronic content

(76) Inventor: Henry Thomson Lynch, The Woodlands, TX (US)

Correspondence Address: HENRY LYNCH, 54 SKY TERRACE PL., THE WOODLANDS, TX, 77381, US

(21) Appl. No.: 11/470,255

(22) Filed: Sep. 6, 2006

Related U.S. Application Data
(60) Provisional application No. 60/596,182, filed on Sep. 7, 2005.

(51) Int. Cl. H04B 1/00

(52) U.S. Cl. 375/142

(57) ABSTRACT

A server system receives information from a client and publishes the information over the Internet. The information includes textual, graphical, or other digitized forms of informational data such as geographic data, a Latitude and/or Longitude, an address, a partial address, an altitude, a region, or the like. The server system stores the information from the client, processes the geographic data associated with the information, converts the geographic data to a standardized format, and associates the geographic data with the posted data as geographic metadata. The data and geographic metadata is then indexed for optimized retrieval by the client system. In response to a request from a client system, paired with global positioning or spatial data the server system returns published information aggregated and summarized based on the proximity of the stored coordinates to those passed to the server system by the requesting client system.

Generally, the present invention relates to a computer method and system for publishing and later retrieving information. More specifically, the information is published and retrieved over the Internet using geo coded data processing techniques to enable users to locate information based on geographical location.

### BACKGROUND OF THE INVENTION

Currently, an easy way of publishing information over a network, such as the Internet, is known as a weblog or “blog.” Blogs have come into common use by individuals, groups and businesses. These weblogs typically consist of individual postings of information that are organized under the identity of the publisher. The weblogs are currently published and stored in chronological order for later retrieval and viewing across the internet by individuals or computer programs known as aggregators. Aggregators are programs that, at timed intervals, retrieve an xml document from the website of the publisher that contains a listing of the most recent postings on the weblog site. Readers of weblogs currently have the ability to read weblog entries grouped by individual authors, a select grouping of individual authors, or grouped chronologically based on some subset of authors or topics within a web site known as a portal. A drawback of the organizational structure of blog publishing however is that there is no method in common practice which enables users or automated aggregators to locate specific weblog postings based on geographic information.

### SUMMARY OF THE INVENTION

According to embodiments of the invention, methods provide geographically aggregated publications to a user of a website. Electronic collections of published data are available to users of a website and users are also provided access to publish data to the website and navigate pieces of the published data. Controls are provided for users to select collections of content and the method maintains geographic data for each piece of the published data. The method receives a retrieval request that includes geographic information and returns a collection of individual pieces of published data having geographic data related to the geographic information found in the request.

According to alternative embodiments, the geographic data is based on geographic coordinates, such as, for example Latitude and Longitude, a country, a state, a county, a city, a street address, a partial street address, an altitude, a genre, a geographic region, and the like. The geographic data can also be based on subcategories of data within a predefined scope of a provided location. In other embodiments, the method converts the geographic data to a standard system format.

In some embodiments of the present invention, the published data is a weblog and the returned collection of published data is returned in response to a query by an application running on a computer system. In other embodiments, the individual pieces of published data are collected by the geographic data provided by the user and displayed in a format suitable for viewing in a web browsing application. The individual pieces of published data are collected by the geographic data provided and displayed in a format suitable for consumption by an application running on a computer system and the collection of data retrieved is in an xml based format.

According to yet other embodiments, the method for organizing published data includes submitting electronic data for publication and storage over an electronic network, where the electronic data includes geographic specific information. The published and stored electronic data is associated with the geographic specific information and users are allowed access to the published and stored electronic data by including a geographic reference. In some embodiments the users geographic reference can be, for example, a geographic region selected by the user, a geographic region determined by the users address or physical location, a country, state, providence, county, or city, selected by the user, a genre, an altitude, an area of interest, or the like. The method also retrieves published and stored electronic data having geographic specific information similar to the users geographic reference.

### DETAILED DESCRIPTION OF THE EMBODIMENTS

The present invention is described in detail below with reference to the attached drawings figures, wherein:

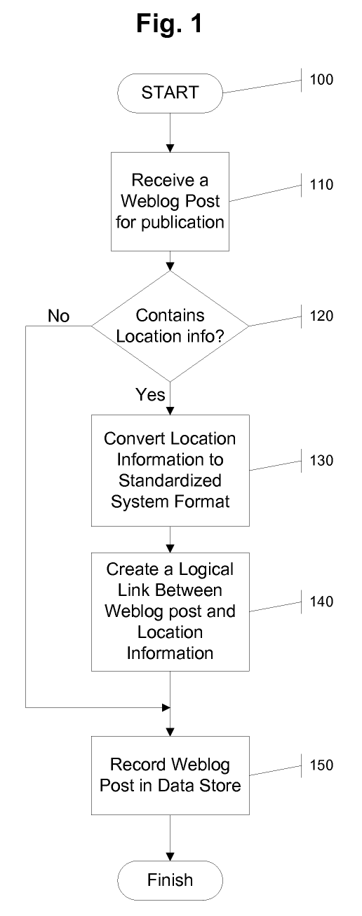

FIG. 1 is a flow chart illustrating a method for indexing by location information in accordance with an embodiment of the invention; and

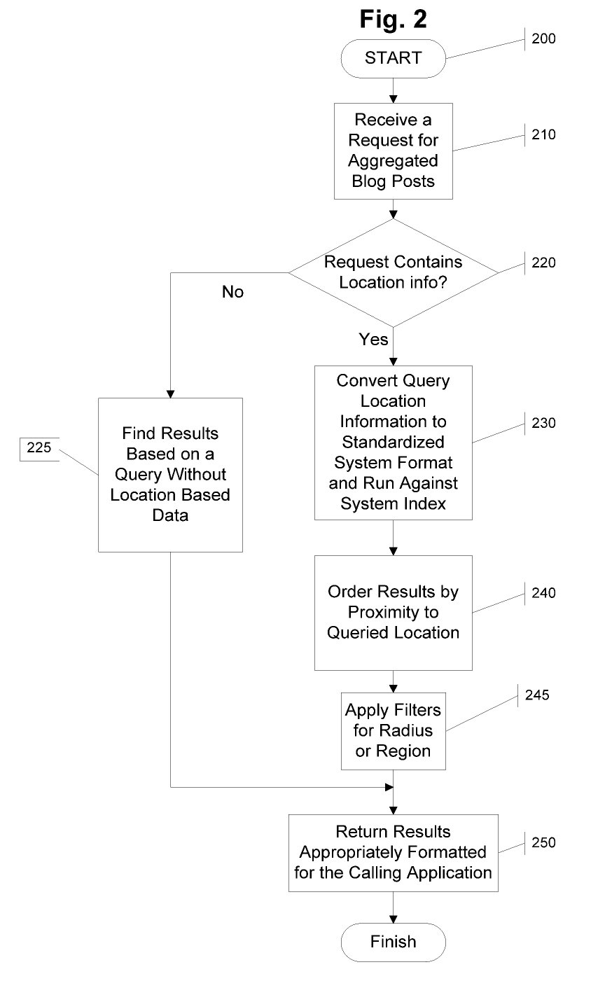

FIG. 2 is a flow chart illustrating a method for retrieval of posts according to location information passed in with a query in accordance with an embodiment of the invention.

### DETAILED DESCRIPTION OF THE EMBODIMENTS

The present invention provides a method of organizing published weblogs.

According to one aspect of the invention, as illustrated in FIG. 1, when a publisher is entering content into a web page or other application used for publishing information to weblogs 110, the user is presented with an option of entering geographical information associated with the content to be published, and the system will determine if any geographical information has indeed been submitted with the post 120. Geographical information can be, but is not limited to, an address, a zip code, a set of Latitude and Longitudinal coordinates, a city, a county, a state, a country, combinations thereof, and the like. The coordinates are then converted to a standardized format on a server 130, and linked to the published information in a database 140, which is then indexed based on the standardized geographic system format for later retrieval 150. According to an alternative embodiment, the information entered can be any information that associates the material to be published to a particular person, region, culture, event, occurrence, sport, hobby, interest, combination thereof, or the like.

In one embodiment as represented by FIG. 2, when a user visits a page of the website that offers the option of entering a geographic location 220, or other particular identifying information as a means of identifying the posts that need to be retrieved 225, the user that enters the information will receive a list of weblog postings that are primarily aggregated and filtered according to the geographic information or other particular identifying information entered by the publisher 250. According to embodiments using geographic identifying information, the retrieved page then shows a list of posts that were published and associated with coordinates similar to coordinates entered by the publisher upon publishing the weblog. The coordinates can be, but are not limited to coordinates located within a certain distance of the location entered by the user or the like. According to yet other embodiments, the retrieved page may also be supplemented with links or controls allowing the user to “subscribe” to the feeds at this location with an aggregator or feed reader application. According to some embodiments, the subscription can be differentiated by varying radius' from the location entered, for example, subscriptions to blog postings in the area within 600 yards, 1 mile, 10 miles, and the like of the geographic coordinates entered upon publication 245.

In another embodiment the user would enter a specially formatted url into an aggregator or feed reader application. This specifically formatted url would retrieve a specially formatted xml document that would mimic the grouping and filtering behaviors described herein.

According to an embodiment, upon retrieving weblog postings, the postings are presented to a user or aggregator program from an Internet site based on a geographic location or set of geographical coordinates 240. This method allows users or aggregation programs to filter weblog information for the syndication feed or web page requested.

What is claimed is:

1. A method for providing geographically aggregated publications to a user of a website, comprising:
providing an electronic collection of published data;
providing a user access to publish data;
allowing the user to navigate pieces of the published data;
providing controls for users to select other collections of content;
maintaining geographic data for each piece of the published data;
receiving a retrieval request wherein the request includes geographic information; and
returning a collection of individual pieces of published data having geographic data related to the requested geographic information.

2. The method of claim 1, wherein the geographic data is based on geographic coordinates.

3. The method of claim 1, wherein the geographic data is selected from the group consisting of Latitude and Longitude, a country, a state, a county, a city, a street address, a partial street address, an altitude, a genre, a geographic region, and the like.

4. The method of claim 1, wherein the geographic data is based on subcategories of data within a scope of a provided location.

5. The method of claim 1, further comprising converting the geographic data to a standard system format.

6. The method of claim 1, wherein the published data is a weblog.

7. The method of claim 1, wherein the returning of the collection of published data is in response to a query by an application running on a computer system.

8. The method of claim 1, wherein the individual pieces of published data are collected by the geographic data and displayed in a format suitable for viewing in a web browsing application.

9. The method of claim 1, wherein the individual pieces of published data are collected by the associated geographic data and displayed in a format suitable for consumption by an application running on a computer system.

10. The method of claim 1, wherein the collection of data retrieved is in a format suitable for consumption by a computer based application.

11. A method for storing content with geographical metadata in a standardized fashion, comprising:
providing pages for users to upload content to a server system;
providing controls that enable the user to input geographical information; and
maintaining the geographical information with the uploaded control by the user such that the uploaded content can be retrieved based on the geographic information.

12. The method of claim 11, further comprising, prompting a user to enter the geographical information with the content that is being uploaded for publishing.

13. The method of claim 11, wherein the geographical information is stored in relation to the uploaded content.

14. The method of claim 11, further comprising, upon receiving a retrieval request for uploaded content, matching the geographical information maintained with the uploaded content with geographic information associated with the retrieval request.

15. The method of claim 11, wherein the geographical information is validated and stored in a standardized format for the server system.

16. The method of claim 14, wherein the geographical information is selected from the group consisting of Latitude and Longitude, a country, a state, a county, a city, a street address, a partial street address, an altitude, a genre, a geographic region, an interest of the user, a hobby, and the like.

17. A method for organizing published data, comprising:
submitting electronic data for publishing and storing over an electronic network, wherein the electronic data includes geographic specific information;
publishing and storing the electronic data in association with the geographic specific information;
allowing a user access to the published and stored electronic data, wherein the user includes a geographic reference; and
retrieving published and stored electronic data having geographic specific information similar to the users geographic reference.

18. The method of claim 17, wherein the geographic specific information is selected from the group consisting of a Latitude and Longitude, a country, a state, a county, a city, a street address, a partial street address, an altitude, a genre, a geographic region, and the like.

19. The method of claim 18, wherein the published and stored electronic data is a weblog.

20. The method of claim 18, wherein the geographic reference is data associated with a user and is selected from the group consisting of a Latitude and Longitude, a country, a state, a county, a city, a street address, a partial street address, an altitude, a genre, a geographic region, and the like and wherein the geographic reference data matches the geographic specific information published and stored with the electronic data.
